(19) United States
(12) Patent Application Publication
(10) Pub. No.: US 2003/0071958 A1
(43) Pub. Date: Apr. 17, 2003

(54) Cholesteric liquid crystal device for writing, inputting, and displaying information

(76) Inventors: Bao-Gang Wu, Murphy, TX (US); Shushan Li, Plano, TX (US); Yong-Jing Wang, Ossining, NY (US); Jianmi Gao, Richardson, TX (US); Ruihai Sun, Amarillo, TX (US); Yong Nam Kang, Wylie, TX (US); Ying Sun, Livermore, CA (US); Gang Chen, Plano, TX (US)

Correspondence Address: J.C. Patents, Suite 250, 4 Venture, Irvine, CA, 92618, US

(21) Appl. No.: 09/976,850

(22) Filed: Oct. 12, 2001

(51) Int. Cl. G02F 1/1335

(52) U.S. Cl. 349/156

(57) ABSTRACT

A liquid crystal device for writing, inputting, and displaying information comprises: a first substrate, a second substrate, and a cell structure sandwiched between the two substrates, defining a plurality of isolated subcells. Means for applying an electric field to drive states of the cholesteric liquid crystal in the subcells is coupled to the electrodes. An electromagnetic sensitive panel is positioned proximately under the surface of the second substrate for receiving an electronic/magnetic signal transmitted by a writing tool. In use, when the tip of the writing tool is forced again and moved around the surface of the first substrate, a true track of the movement of the tip is directly shown on the writing surface, while information of the movement of the tip of the writing tool is sensed by the electromagnetic sensitive panel simultaneously.

### BACKGROUND OF THE INVENTION

1. Field of Invention

The present invention is directed, in general, to liquid crystal display (LCD) devices, and more specifically, to a writing board employing cholesteric liquid crystals, on which information can be written via application of a pressure and erased via application of a voltage. The present invention also relates to a cholesteric liquid crystal writing/display panel on which information can be written via application of a pressure and which can function as an LCD. The present invention further relates to a cholesteric liquid crystal device which combines the functions of a writing board, a display device, and a touch panel.

2. Description of Related Art

Liquid crystal display devices are undergoing great improvements. Their applications have extended from traditional information display devices, such as computer monitors and television sets, to information billboards, smart cards, touch panels and so on.

It is well known that, under certain conditions, the state of a cholesteric liquid crystal (CLC) material can be changed by application of an electric field or mechanical stress. This unique property of cholesteric liquid crystal has been used to write information onto, or erase information from, a cholesteric liquid crystal display device. Such devices have been described in U.S. Pat. No. 4,525,032 and U.S. Pat. No. 6,104,448.

U.S. Pat. 4,525,032 discloses a cholesteric liquid crystal device for producing indicia of human handwriting. The cholesteric liquid crystal device comprises a layer of cholesteric liquid crystal material contained between a front and a rear wall with electrodes. A pen having a tip is provided for contacting the front wall and changing the observed state of the cholesteric liquid crystal layer at the positions traced by the pen tip. One method of changing the state of the cholesteric liquid crystal layer is to physically deform the front wall by applying localized pressure from the movement of the pen tip. However, it has been shown that the resolution is low and the quality of the displayed image is poor because the cholesteric liquid crystal material is not locally constrained along the pass of the pen tip movement.

U.S. Pat. No. 6,104,448 discloses a light modulating cell comprising a liquid crystal light modulating material of cholesteric liquid crystal and polymer with the polymer being distributed in phase separated domains in the cell. The light modulating cell of U.S. Pat. No. 6,104,448 is prepared by introducing a solution of cholesteric liquid crystal and polymer (or polymer precursor) into the cell, and polymerizing the polymer (precursor) in situ. Under polymerization conditions, polymer phase separates from the cholesteric liquid crystal and forms phase separated polymer domains or subcell sidewalls. It is claimed that such formed subcell sidewalls serve to isolate the pressure applied to only regions directly under a writing stylus. However, the inventors of the present invention discovered that the above structure has inherent drawbacks. First, the subcell sidewalls are formed by in situ polymerization in a solution of cholesteric liquid crystal and polymer monomer. It is very difficult, if not impossible, to control the purity of the polymer walls. Small molecules, such as the cholesteric liquid crystal and the unpolymerized monomers, will be entrapped in the polymer walls so as to weaken the strength of the subcell sidewalls. Such polymer sidewall is not strong enough to isolate the effect of the applied pressure only to the regions directly under a writing stylus. Secondly, it is very difficult, if not impossible, to form uniform enclosed subcells by such in situ polymerization. Again, subcells with various size and shape and non-isolated subcells will adversely affect the resolution. Thirdly, the cholesteric liquid crystal inevitably contains residuary polymer or monomers after the polymerization, which will reduce the brightness and the contrast of the image on the cholesteric liquid crystal cell.

Efforts have also been made to develop data input devices associated with liquid crystal display, such as various touch panels. One type of touch panels is so-called resistive touch panel. Usually, a liquid crystal display panel is placed under or behind the touch panel to display the information (image) output from the electronic device. A disadvantage of such resistive touch panel is that the liquid crystal display panel must be placed behind the lower substrate. Thus, the image displayed on the liquid crystal display panel has to be viewed through the two substrates of the touch panel, resulting in lower contrast, smaller view angle, and reduced brightness. In addition, the image shown on the display panel is not the true physical image directly generated by the pen, rather, the image is modulated or manipulated by the electronic device.

Therefore, what is needed in the art is a writing board on which an image (information) can be written and erased easily with high resolution and quality and which is “touch insensitive”. More specifically, a rewritable cholesteric liquid crystal writing board with a simple writing and erasing mechanism is needed to displace the traditional writing method. There is also a need for a cholesteric liquid crystal device, which can be written on and directly show original written information with high resolution, high brightness and high contrast ratio, and at the same time, which can function as a liquid crystal display and an information receiving panel.

### SUMMARY OF THE INVENTION

To address the above-discussed deficiencies of the prior art and the needs in the art, one aspect of the present invention to provides a cholesteric liquid crystal writing board that can be written by application of a localized pressure with a tip of a writing tool and be erased by applied voltage.

In the attainment of the above-described purpose, the present invention provides a structure of cholesteric liquid crystal writing panel with separated subcells that isolate the cholesteric liquid crystal fluid contained in the subcells, so that each subcell can be driven independently by application of an external pressure with a writing tool. The present invention also provides methods of manufacturing the panel.

According to one aspect of the present invention, a cholesteric liquid crystal writing board is provided. The cholesteric liquid crystal writing board comprises:

a transparent, flexible upper substrate comprising a first electrode, the upper substrate providing a writing surface for receiving a tip of a writing tool;

a lower substrate comprising a second electrode, the lower substrate being positioned facing the upper substrate;

a cell structure sandwiched between the upper substrate and the lower substrate, the cell structure having subcell sidewalls, wherein the subcell sidewalls, together with the upper substrate and the lower substrate, define a plurality of isolated subcells which are substantially not in fluid communication with one another; and

a cholesteric liquid crystal filled in the subcells, wherein the subcell sidewalls are substantially free of unpolymerized monomers and cholesteric liquid crystal molecules and are rigid enough so that, when the tip of the writing tool is forced against the writing surface and causes a flow of the cholesteric liquid crystal inside a subcell located directly under the tip, subcells neighboring said subcell will not be affected by the tip.

According to another aspect of the present invention, a cholesteric liquid crystal writing/display device is provided. The cholesteric liquid crystal writing/display device comprises:

a first transparent, flexible substrate having a first surface for writing information thereon by a writing tool and an opposite second surface;

a second substrate having a first surface facing the second surface of the first substrate;

a first electrode attached onto the second surface of the first substrate, wherein the first electrode comprises a predetermined number of conductive strips parallel to one another;

a second electrode attached onto the first surface of the second substrate, wherein the second electrode comprises a predetermined number of conductive strips parallel to one another, wherein the conductive strips of the first electrode are perpendicular to the conductive strips of the second electrode;

a cell structure sandwiched between the second surface of the first substrate and the first surface of the second substrate, the cell structure containing a plurality of isolated subcells defined by subcell sidewalls and the first and the second substrates, wherein the subcell sidewalls are substantially free of unpolymerized monomers and cholesteric liquid crystal molecules; and

a cholesteric liquid crystal filled in the subcells;

wherein the number and dimension of the conductive strips of the first and the second electrodes are so chosen that, when viewed from a direction perpendicular to the first surface of the first substrate, an area of each of the isolated subcells surrounded by the subcell sidewalls is fully covered by one of the conductive strips of the first electrode from a top side and by one of the conductive strips of the second electrode from a bottom side.

According to still another aspect of the present invention, a cholesteric liquid crystal device for writing, inputting, and displaying information is provided. It comprises:

a transparent, flexible, first substrate having an upper surface and an opposing lower surface, the upper surface serving as a writing surface for receiving a pressure from a tip of a writing tool, wherein the writing tool comprises means for generating a magnetic field;

a second substrate having a first surface and an opposing second surface, the second substrate being positioned below the first substrate with the first surface facing the lower surface of the first substrate;

a cell structure having subcell sidewalls sandwiched between the first substrate and the second substrate, wherein the subcell sidewalls define a plurality of isolated subcells;

a cholesteric liquid crystal contained in the subcells;

means for applying an electric field to drive states of the cholesteric liquid crystal in the subcells; and

an electromagnetic sensitive panel positioned proximately under the second surface of the second substrate for receiving the magnetic field generated by the writing tool;

wherein, when the tip of the writing tool is forced again and moved around the writing surface, a true track of the movement of the tip is directly shown on the writing surface, while information of the movement of the tip of the writing tool is sensed by the electromagnetic sensitive panel simultaneously.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a sectional view of the cholesteric liquid crystal writing board of the present invention.

FIG. 2 illustrates the top view of a cell structure (honey cone structure) of the present invention.

FIG. 3 shows two electrodes having a certain number of parallel conductive strips used in one embodiment of the present invention.

FIG. 4 is a top view of a cell structure having rectangular subcells according to one embodiment of the present invention.

FIG. 5 illustrates an exploded view of a cholesteric liquid crystal device of the present invention, which combines the functions of a writing board, a display device, and a touch panel.

### DETAILED DESCRIPTION OF THE EMBODIMENTS

One aspect of the present invention provides a cholesteric liquid crystal writing board. The writing board of the present invention has a cell structure sandwiched between two substrates with the upper substrate being transparent and flexible. The cell structure has subcell sidewalls defining a plurality of isolated subcells. The cholesteric liquid crystal is contained and confined inside those isolated subcells. In use, a pressure is applied to the upper surface of the upper substrate, such as by forcing a pen against the surface and moving it around. This localized external pressure causes the flexible upper substrate to deform at locations under the track of the pen movement. The localized deformation of the upper substrate, in turn, causes the cholesteric liquid crystal to flow inside those isolated subcell that are directly located under the track of the pen movement and, thus, changes the state of the cholesteric liquid crystal in those subcells. When the pressure is removed or the pen moves to other locations, the deformed areas of the upper substrate return to their original or normal state, which also causes the cholesteric liquid crystal in those affected subcells to flow. It has been noticed that the flow caused by application of a pressure and the flow caused by removal of the pressure tend to drive the cholkesteric liquid crystal to the same state, the planar state.

The subcell sidewalls are made strong and rigid enough so that the impact of an applied pressure and the flow or molecular movement of the cholesteric liquid crystal caused by the applied pressure are limited to those individual subcells directly receiving the pressure. In the writing board of the present invention, no polymer net structure is necessary, no monomer or polymer needs to be added into the cholesteric liquid crystal. Therefore, the writing board of the present invention has a high resolution, and high quality images. The writing board containing cholesteric liquid crystal is capable of indefinite zero field stability of optical images and has complete gray scale capability. When proper electrodes or conductive matrix are coupled to the writing board, the writing board can function as a FMLCD (Fast-response Multi-stable Liquid Display). Details of FMLCD have been described in U.S. Pat. Nos. 5,625,477 and 5,661,533, both of which are incorporated by reference hereby in their entirety.

Because of the strong, rigid subcell sidewall structure, the writing board of the present invention has the advantage of “touch insensitive” for a contact from a large tip such as human fingers, when the size of the subcells is smaller than that of the large tip. In other words, a touch of the writing/displaying surface of the writing board by a human finger will not be able to change the images on the writing board if the size of the subcells is smaller than finger tip.

As well known by those skilled in the art, there are two basic states of cholesteric liquid crystals. The first state is a focal conic state that mostly lets lights transparent through. It appears as a dark state if black paint is applied to the rear substrate and acts as light absorber. The second state is a planar state that reflects lights in certain color and appears as the bright state. Among others, electric field and pressure are two efficient means to drive a cholesteric liquid crystal between the focal conic state and the planar state. When a pressure is applied onto the cholesteric liquid crystal cell, which causes a flow of the cholesteric liquid crystal. All of, or part of the cholesteric liquid crystal in the flowing region will be driven from the focal conic state to the planar state depending on the strength of pressure. A special designed electric waveform can also toggle the state of a cholesteric liquid crystal between the planar state and the focal conic state. For example, a high voltage applied will change the cholesteric liquid crystal to the planar state. A low voltage applied will change the cholesteric liquid crystal to the focal conic state. Combining the electric field and the pressure mechanism together, there are several different arrangements for driving the cholesteric liquid crystal used in the present invention. The cholesteric liquid crystal used in the present invention can reflect visible light having a center wavelength: λ₀=n*p, where n is average refractive index of the cholesteric liquid crystal, and p is the pitch of the cholesteric liquid crystal.

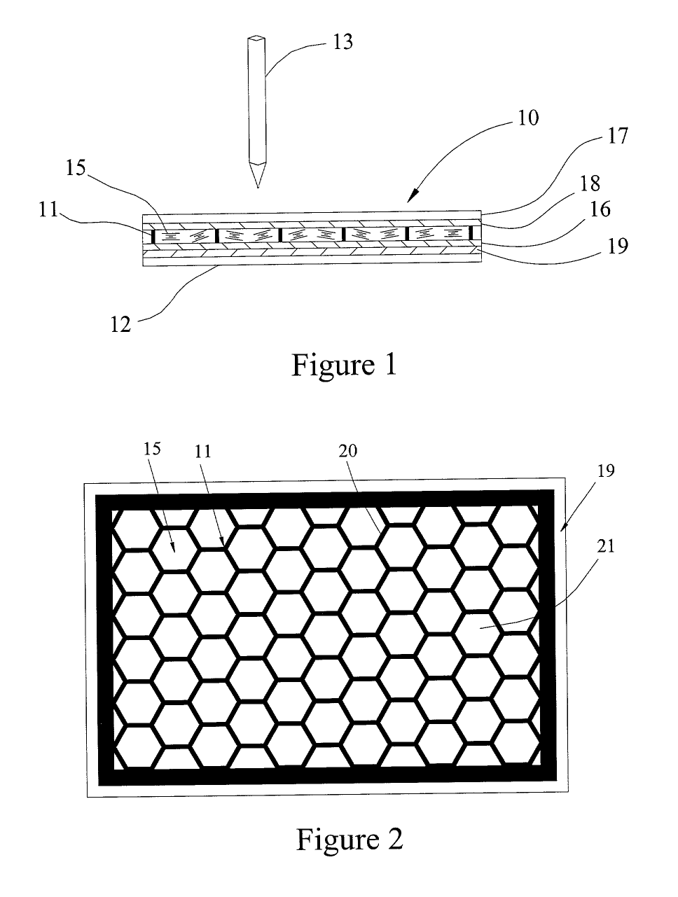

Referring now to the drawings, a cholesteric liquid crystal writing board 10 according to an embodiment of the present invention is shown in FIG. 1. The writing board 10 comprises a lower substrate 19 with an electrode 16 on it. The substrate 19 can be any kind of substantially planar bases appearing as black or other color of choice, such as glass plate, plastic films, metal sheets, or the equivalent with electrodes attached on its inner surface. The black background can be instinct color of the material or black painted layer 12. A layer of cholesteric liquid crystal material 15 is disposed on substrate 19. The cholesteric liquid crystal layer 15 is covered by an upper substrate 17. The upper surface of upper substrate 17 provides a writing and/or viewing surface. The upper substrate 17 can be made of any material that is transparent and deformable under a pressure generated by a writing device. Such material includes, but not limited to, PES with hard coating, or any flexible transparent film, which also blocks moisture, and is anti-scratch. A transparent conductive material layer, for example an indium tin oxide (ITO) layer, is deposited on substrate 17 serving as an upper electrode 18. Both electrode 16 and electrode 18 can be a single piece covering the entire area of the corresponding substrate as one large pixel, or formed by conductive strips like normal passive STN LCD structure, whereby writing board (or panel) 10 can be erased totally or partially by the application of a voltage to the electrodes. Electrodes 16 and 18 also can be an N×M conductive matrix such as those known in the art. The upper substrate 17 should be thin and flexible enough to transfer the pressure generated by a writing device, such as a pen tip, onto the cholesteric liquid crystal layer 15. In use, information can be written by applying a localized external pressure onto the writing surface of the upper substrate 17 and erased by applying a voltage onto the cholesteric liquid crystal layer through electrodes 16 and 18. When substrates 17 and 19 are made from proper conductive materials, they can also function as electrodes. In such cases, electrodes 16 and 18 will be not necessary.

A cell structure (or microstructure) 11 is formed between the two substrates. Cell structure 11 has subcell sidewalls 20 which, together with the substrates, form a plurality of subcells 21 as shown in FIG. 2. The cholesteric liquid crystal layer 15 is contained and confined in individual subcells 21. Subcells 21 are independent or isolated from one another so that, when a local pressure is applied onto a subcell 21 and causes a state change of the cholesteric liquid crystal material in that subcell, subcells neighboring that subcell will substantially not be affected by the pressure. In other words, the state(s) of the cholesteric liquid crystal material in these neighboring subcells will substantially not be changed under such a localized pressure. Preferably, subcells 21 are substantially not in fluid communication with one another. The subcells 21 can have honeycomb (hexagonal), square, rectangular, circle, or other irregular or regular shapes as viewed from a direction perpendicular to the viewing surface of upper substrate 17. For the purpose of writing, a honeycomb shape is preferred. As will be discussed later, under certain circumstances, other shapes may become favorable. The size of subcells 21 may vary depending on the desired application and resolution of the writing board and the size of the tip of writing tools. Preferably, the size of subcell 21 corresponds to the size of a writing device such as the tip of a pen or stylus 13 so that high resolution and sharp image can be achieved. For example, for a writing tip in the range of about 0.1 to 0.2 mm, the size of subcells 21 can be in the range of about 0.2 to 0.5 mm. In some applications, the size of the subcell can be 1 to 3 times of the size of the writing tip. Of course, the present invention is not limited to the above ratio and size. For the purpose of this invention, the size of a subcell 21 is defined as the diameter or the diagonal of the shape of the subcell as viewed from a direction perpendicular to the viewing surface of substrate 17.

Spacers (not shown) can be placed in subcells 21 to help separate the two electrodes and maintain the cell gap (distance between the two electrodes). Any suitable spacers known in the art can be used.

In order to be able to limit the impact of the applied pressure by a pen tip to only the subcell(s) directly under the pathway of the pen tip movement on the writing board, subcell sidewalls 20 should be strong and rigid enough. If the subcell sidewalls are strong and rigid enough, when a pressure is applied onto a relative large area (which covers a plurality of subsells 21) of the writing surface, such as by touching the writing surface with a human finger, such a pressure will not be able to cause a state change of the cholesteric liquid crystal within those subcells. Thus, the writing/viewing surface of the cholesteric liquid crystal writing board of the present invention is touch insensitive, i.e., the image on the writing board cannot be changed or erased by casual touch of the writing surface with human finger. The subcell sidewalls 20 can be made by any proper material that is stable in the cholesteric liquid crystal and can withstand the pressure required for writing. Preferably, subcell sidewalls 20 are made from photoresistance, such as a negative photoresistance made by Hoechst-Celanese Company, the product number of which is OMR-83 or printing polymer, such as polyimide. Preferably, the sidewall materials are instinct adhesive Otherwise, an adhesive glue such as a pressure sensitive adhesive (PSA) has to be coated on one or both of the two substrates before attaching the subcell sidewalls thereto. For example, when polyimide is used to build the subcell sidewalls, such adhesive glue needs to used. More preferably, the subcells sidewalls are made transparent or have a black color.

To obtain a high quality cholesteric liquid crystal writing board, e.g., high resolution, high brightness and high contrast, it is important for the cell structure to have a high aperture ratio, proper subcell shape and size, and high strength of subcell sidewalls. For purpose of the present invention, the aperture ratio of the cell structure is defined as the ratio of the area surrounded by the subcell sidewalls as viewed from a direction perpendicular to the viewing surface of the writing board to the total of the area surrounded by the subcell sidewalls plus the area occupied by the subcell sidewalls themselves. Because subcell sidewalls 20 are in direct contact with the upper substrate 17 and the lower substrate 19 (or the electrodes thereon), respectively, no cholesteric liquid crystal layer is formed between the areas of the subcell sidewalls and the substrates. Thus, areas on the viewing surface corresponding to the area of the subcell sidewalls are not able to show images. Those are non-active areas. A higher aperture ratio means that relatively more area is available for receiving the cholesteric liquid crystal, also means less nonactive area, that means increased brightness and quality of the image. Although, usually the non-active areas are not desirable, if the subcell sidewalls in those non-active areas are made transparent or have a black color, this will increase the contrast ratio. A conductive matrix (such as an upper electrode with x-direction strips and a lower electrode with y-direction strips) used in a liquid crystal display also has an aperture ratio defined as the active area of the conductive matrix divided by the total area occupied by the conductive matrix. As well known in the art, overlapped areas between the x-direction strips and the y-direction strips of a conductive matrix constitute the pixel areas (which define pixels). In the present invention, the line gaps of a conductive matrix and the size and shape of subcell sidewalls can be matched so that a higher general aperture ratio will be achived. In other words, the general aperture ratio not only depends on the aperture ratio of the cell structure and the aperture ratio of the conductive matrix, but also depends on how well these two are matched. If each pixel area of the conductive matrix has the same size and shape as that of the subcells, and is aligned so that each pixel area fully covers one subcell, a maximum general aperture ratio is achieved. In the follow descriptions and in the claims, where only writing board is concerned, the term “aperture ratio” is referred to the aperture ratio of the cell structure, otherwise, the term “aperture ratio” is always referred to the general aperture which has the usually accepted meaning in the art. Preferably, the aperture ratio is not less than about 70%, more preferably, not less than 90%. Cell shape also affect the image quality. Under the same aperture ratio, different cell shapes may result in different image quality. A preferred shape of subcells 21 is hexagonal. As shown in FIG. 2, there are no “dead areas” (areas that cannot be written on by a pen) between the hexagonal subcells. When a pressure is applied onto a subcell by a pen tip, its impact is easily transferred to the cholesteric liquid crystal material allover the subcell with no dead comers inside the subcell. Preferably, all subcells 21 have the same size and shape as shown in FIG. 2. If desirable, a cell structure can also include subcells of different shape and size. The purity of cholesteric liquid crystal material also affects the display quality. For example, uncured monomer or polymer additives contained in the cholesteric liquid crystal material will adversely affect the brightness and the quality of the image. The steepness of electrical-optical curve will become deteriorated. Eventually, the panel will become not good enough for displaying high volume information.

The thickness of the cell wall is another important parameter. In terms of the aperture ratio, subcell sidewalls 20 should be as thin as possible so as to reduce the nonactive area on the viewing surface of the upper substrate 17. But, if subcell sidewalls 20 are too thin, its strength will not be high enough. According to the present invention, the preferred thickness of the subcell sidewalls 20 is about 10 to 40 μm. In one embodiment, the thickness is about 30 μm.

The thickness of cholesteric liquid crystal layer 15 (it is also called “cell gap”) can be in a range from about 1 to 30 μm, a range of 1-10 μm is preferred. In one embodiment of the present invention, the thickness of cholesteric liquid crystal layer 15 is about 2 μm.

The methods to make cell structure 11 include, but not limit to, the following: (1) The cell structure 11 can be formed by the printing printable material directly on to the substrate by means of screen printing or offset printing or ink jet printing. (2) The cell structure 11 can be formed by lithography method, in which a photosensitive material layer is deposited onto the substrate and patterned, then selected portions are removed. Types of photosensitive material that can be used in the present invention include, but not limited to, photo-definable material such as photoresist and photo-sensitive polyimide. (3) The cell structure 11 can be integrated into substrates by modeling the cell structure on the substrates utilizing microplastic technology. By mating two substrates together, the subcells 21 will be formed to retain the cholesteric liquid crystal fluid therein. The writing board 10 can be formed by filling cholesteric liquid crystal into the subcells formed on substrate 19 and laminating substrate 17 onto substrate 19. For example, the method disclosed in U.S. Pat. No. 5,949,513 can be used in the present invention, which patent is incorporated by reference hereby in its entirety.

When a pressure is applied by a writing device onto the writing surface of the upper substrate 17, deformations will occur in those subcells (or microcells) lying directly under the applied pressure. The subcell walls 20 of the cell structure 11 substantially limit the effect of the deformation of the upper substrate 17 on the cholesteric liquid crystal layer 15 to only those subcells lying directly under the applied pressure. Thus, the applied pressure causes the flow of cholesteric liquid crystal in only those subcells that directly receive the pressure. The flow of the cholesteric liquid crystal layer 15 is isolated in each subcell, thus, the state of the cholesteric liquid crystal in each microcell can be changed independently. If the pressure is not enough to flow the entire subcell, only part of the cholesteric liquid crystal in the subcell is changed to planar bright state. That is to say, the different pressure of the tip from the pen on the front surface will generate different gray scale on the pixel itself. If only black and white are supposed to be two states on the system, a relative high pressure touch is necessary to get good contrast ratio.

The flow of the cholesteric liquid crystal by applied pressure causes a state change from focal-conic (dark) to planar (bright), so that a focal-conic dark state erasing is required. A low voltage can be applied onto the cell structure 11 through electrodes 16 and 18. The voltage will change the cholesteric liquid crystal material contained in the cell structure 11 to the focal conic state; thus, erase all necessary area to dark. Then, a tip 13 (stylus) is used to apply pressure onto the writing surface of the upper substrate 17 as a writing tool to write information onto the cholesteric liquid crystal writing board. The pressure from the tip results in flows of the cholesteric liquid crystal inside individual subcells that are directly under the pathway of the tip movement and, thus, changes the cholesteric liquid crystal to the planar state, which will reflect light and appear as bright states. These two stages (erasing and writing) are repeatable within the lifetime of devices. Each of the states is a stable state. Once a state is established by pressure, heating, light, electrical or magnetic field, it will stay at that state under zero field, which significantly reduces energy consumption because the static image needs no energy to maintain.

Another aspect of the present invention provide a cholesteric liquid crystal writing and displaying device which functions as a pressure writing board and a liquid crystal display (LCD). In this case, the electrodes of writing board 10 are replaced with a conductive matrix to control the state of each subcell (here each subcell can constitute a pixel). Any conventional LCD driver can be used to provide drive signals to each subcell or to groups of subcells. One electrode comprises a plurality of conductive strips parallel to one another and is attached on the surface of the upper substrate. Another electrode also comprises a plurality of conductive strips parallel to one along and is attached on the surface of the lower substrate. The conductive strips of the upper electrode are perpendicular to the conductive strips of the lower electrode. The number and dimension of the conductive strips as well as the line gaps between the conductive strips can be controlled, the relative positions between the two electrodes and the cell structure can be aligned, so that the active areas defined by the overlapped portions of the conductive strips between the two electrodes correspond to the areas of the subcells while the line gaps correspond to the area occupied by the subcell sidewalls. In this way, the high aperture ratio of the cell structure is most efficiently realized. If the subcell sdiewalls are made of a transparent or black material, the line-gap areas always keep dark (if these areas are filled with liquid crystal, the liquid crystal can never get as dark as the subcell side walls), so that the contrast ratio will be further increased. For the purpose of the present invention, the area of a subcell is defined as the area encircled or surrounded by its sidewall. The size of the area is viewed from a direction perpendicular to the substrate. Preferably, the area is open (to the substrate or to the electrode) in the direction perpendicular to the substrate, i.e. the subcells are not covered by the subcell sidewalls from top and bottom sides.

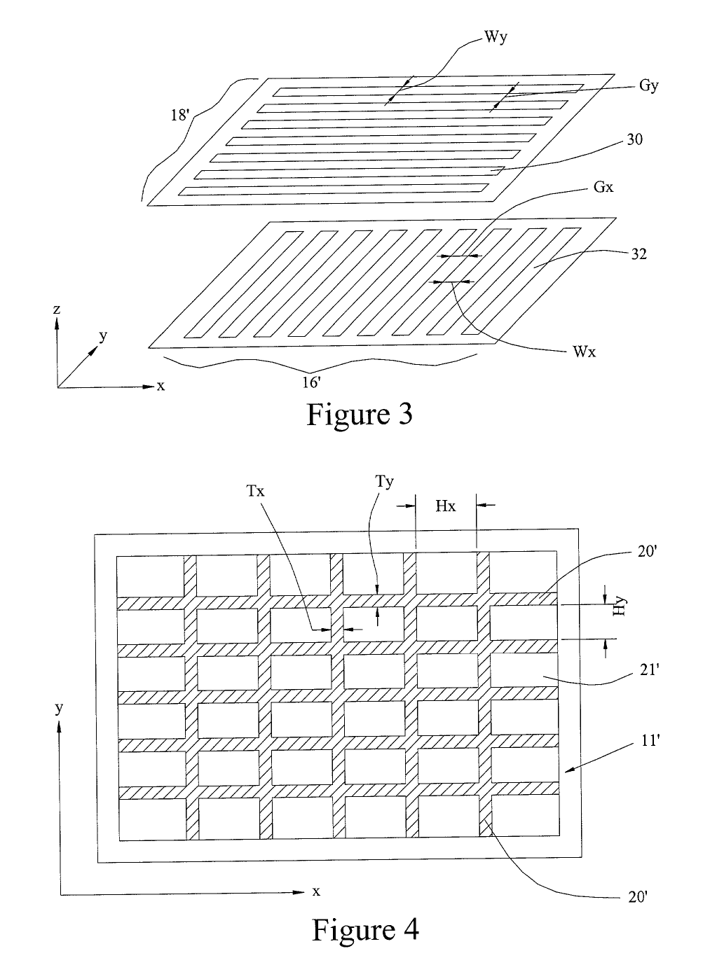

FIG. 3 shows an example of two electrodes having a certain number of conductive strips. As shown, electrode 18′ (which can be formed on the surface of substrate 17) has a plurality of conductive strips 30. If desired, conductive strips of different shape and size can be in the electrode. In this embodiment, all conductive strips 30 are substantially identical and have a rectangular shape. The width of the conductive strip 30 is Wy. The line gap between two neighboring conductive strips 30 is Gy. Preferably, the line gaps of different pairs of neighboring strips are the same. But they can be different if desirable. The conductive strips 30 are substantially parallel to one another along an X-direction.

Electrode 16′ (which can be formed on the surface of substrate 19) has a plurality of conductive strips 32. If desired, conductive strips of different shape and size can be used in the electrode. In this embodiment, all conductive strips 32 are substantially identical and have a rectangular shape. The width of the conductive strip 32 is Wx. The line gap between two neighboring conductive strips 32 is Gx. Preferably, the line gaps of different pairs of neighboring strips are the same. But they can be different if desirable. The conductive strips 32 are substantially parallel to one another along a Y-direction. Preferably, conductive strips 30 are perpendicular to conductive strips 32 when assembled. A person skilled in the art will realize that conductive strips 30 and 32 do not have to have a uniform regular shape. In stead, they can be made into various irregular shapes if desirable.

FIG. 4 is a top view of a cell structure 11′ having rectangular (or square) subcells. Cell structure 11′ has a plurality of subcells 21′ arranged in rows (X-direction) and columns (Y-direction). The width of subcell 21′ along Y-direction is Hy. The width of subcell 21′ along X-direction is Hx. In case of square subcells, Hx=Hy. The thickness of the subcell sidewall 20′ extending along X-direction is Ty. The thickness of the subcell sidewall 20′ extending along Y-direction is Tx. Preferably, the subcell sidewalls 20′ have a substantially uniform thickness and Tx=Ty, and all subcells 21′ have the same size and shape, although subcells with different shape, size, and sidewall thickness can be used in a single cell structure to match that of the electrodes.

When cell structure 11′ is sandwiched between substrate 17 and second substrate 19, therefore, between electrode 18′ and electrode 16′ , conductive strips 30 and conductive strips 32 partially overlap as viewed from Z-direction or from the upper surface of substrate 17. Only these areas defined by the overlapped portions of conductive strips 30 and conductive strips 32 can be driven by an LCD driver and provide active areas or pixels. By adjusting the number, the width, and the line gap of conductive strips 30 and 32, each subcell 21′ can be matched by an active area defined by the overlapped portions of conductive strips 30 and 32. For example, if making the number of conductive strips 30 equal to the number of rows of cell structure 11′, the number of conductive strips 32 equal to the number of columns of cell structure 11′, the width of the conductive strips equal to the width of the subcells (i.e. Wy=Hy, Wx=Hx), the line gap equal to the thickness of the subcell sidewalls (i.e. Gy=Ty, Gx=Tx), and with proper alignment, each subcell 21′ will be covered by one conductive strip 30 from one side (the top side) and covered by one conductive strip 32 from another side (the bottom side). While the areas occupied by subcell sidewalls (non-active areas) match with the line gaps.

From the above discussion, it is clear that in order to best match the conductive matrix with the cell structure, a square or rectangular shape of the subcells is preferred. However, based on the principles of the present invention, a person skilled in the art would recognize that other shapes of subcells and conductive strips can also be used in the present invention.

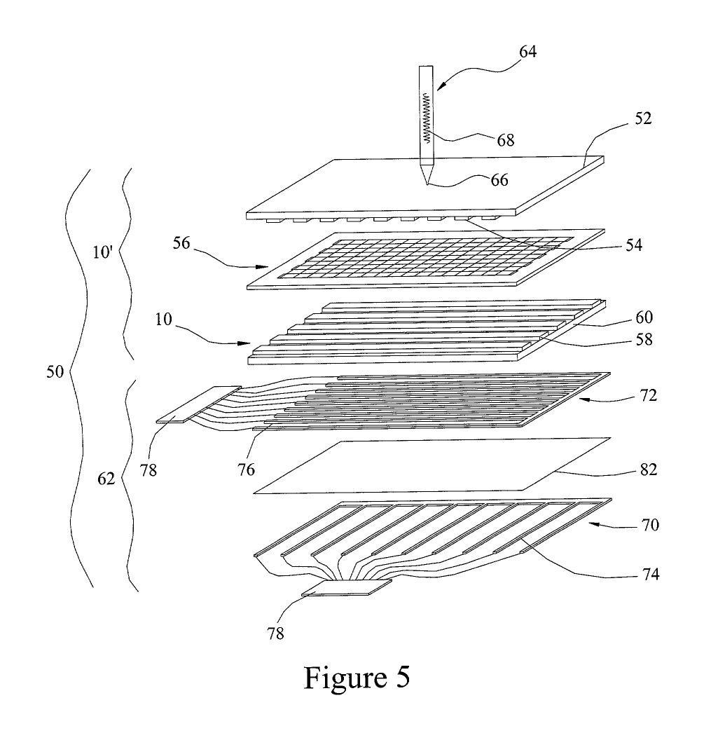

Another aspect of the present invention is to provide a cholesteric liquid crystal device having the functions of a writing board, a display device, and a touch panel. FIG. 5 shows such a cholesteric liquid crystal device 50. The cholesteric liquid crystal device 50 includes a writing/display panel 10′ similar to the writing board 10 shown in FIGS. 1-4, and an electromagnetic sensitive touch panel 62. The writing/display panel 10′ is placed on top of electromagnetic sensitive touch panel 62. Panel 10′ has an upper substrate 52 similar to substrate 17, a lower substrate 60 similar to substrate 19, a cell structure 56 such as those similar to cell structure 11 or 11′ shown in FIGS. 2 and 4 sandwiched between upper substrate 52 and lower substrate 60. An upper electrode 54 and a lower electrode 58 are coupled to upper substrate 52 and lower substrate 60, respectively. In the embodiment shown in FIG. 5, electrodes 54 and 58 are made of rectangular conductive strips similar to those shown in FIG. 3. The conductive strips of upper electrode 54 are perpendicular to that of the lower electrode 58. A cholesteric liquid crystal is deposited in the subcells of cell structure 56. Cell structure 56 may have different shape subcells as discussed above in connection with FIGS. 1-4. A writing tool 64 is provided. Writing tool 64 has a tip 66 for writing on panel 10′ by applying a pressure thereon and a device 68 for electronically/magnetically stimulating electromagnetic sensitive touch panel 62. The device 68 can be a magnetic coil connected to a DC or AC power source, or a piece of permanent magnet. The writing tool 64 can be cordless or wired to electro-magnetic sensitive touch panel 62.

The electric-magnetic sensitive touch panel 62 comprises an x-y matrix for detecting the location of device 68 of writing tool 64. The x-y matrix includes an x-direction sensor 70 and a y-direction sensor 72 perpendicular to each other and separated by an insulation layer 82. The x-direction sensor 70 is formed by a plurality of y-direction ribs or conductive leads 74, which are electrically connected at one of end; the opposite end of which is open for receiving a voltage detector in every pair of neighboring leads. The structure is similar to a comb. One end is connected, and the other end is open. The open side of the conductive leads will be connected to a voltage detector 78 to check the signals. By checking voltage Vi generated by a magnetic field change from the magnetic coil on the writing tool, the detectors 78 give different voltages to tell the location of the writing tool in x direction. According to Faraday's law and Lez's law, the electric voltage will be produced in the conductive circle to generate a reverse change of the magnetic field in the conductive circle against the external magnetic field change from the coil on the moving writing tool. The voltages generated in different conductive leads tell the location and the writing tool's moving direction. The same structure of comb is used for y-direction sensor 72 having conductive leads 76 to form an x-y matrix to tell x and y location at same time. The x and y direction conductive leads are usually separated by a layer of insulator, such as PCB. The voltage generated by device 68 of writing tool 64 is usually amplified by an amplifying integrated circuit (not shown). The electric-magnetic sensitive touch panel 62 does not need direct touching to write information. The above-mentioned x-direction and y-direction are arbitrary and should not limit the structure of cholesteric liquid crystal device 50. In one embodiment, one of x-direction sensor 70 and y-direction sensor 72, such as y-direction sensor 72, can be formed by printing the conductive leads 76 on the back surface of lower substrate 60. Then, insulation layer 82 is coated on the conductive leads 76. Next, conductive leads 74 of x-direction sensor 70 are printed on the insulation layer 80.

It should be understood that above embodiments are only exemplary. Various electromagnetic sensitive touch panels, and x-y matrixes and voltage detectors for detecting the location of a writing tool are known in the art. One such commercially available electromagnetic sensitive touch panel is sold under the name “Hanwang Bi” by Hanwang Technology, Beijing. According to the principles of the present invention taught above, a person skilled in the art will appreciate that, and those conventional electromagnetic sensitive touch panels and x-y matrix and voltage detectors can be combined with the writing board of the present invention.

In use, a user can write on the writing surface of substrate 52 with writing tool 64 by forcing tip 66 of writing tool 64 against the writing surface and moving it around. A true image of the track traveled by the tip 66 of writing tool 64 will show on the writing/display panel 10′. Meanwhile, the information associated with the movement of the tip 66 of writing tool 64 is received by electromagnetic sensitive touch panel 62. The electromagnetic sensitive touch panel 62 accordingly detects the position and movement of tip 66, generates a corresponding signal and sends the signal to an electronic device (not shown), such as PDA, Palm Pilot, e-Book, Tablet, or a computer etc., where the input information can be recorded, or re-displayed on writing/display panel 10′ instantly or later. Electrodes 54 and 58, and electromagnetic sensitive touch panel 62 can be operated separately. If desired, electromagnetic sensitive touch panel 62 can be turned off so that cholesteric liquid crystal device 50 will function just like liquid the crystal writing board 10 shown in FIGS. 1-2, or a voltage can be applied to electrodes 54 and 58 while writing so that the information (image) will not show on panel 10′, but will be received by electromagnetic sensitive touch panel 62.

Electrodes 54 and 58 can also be a conductive matrix (such as the one shown in FIG. 3) driven by a LCD driver, such as LH1560, so that panel 10′ can display information drawn from a data source or a memory like EPROM controlled by a CPU (a computer or a smartchip). In this way, the image, such as handwriting, originally inputted by writing tool 64 can be modulated or manipulated by a device coupled to electro-magnetic sensitive touch panel 62 and sent back through the conductive matrix (54 and 58) to panel 10′ to show a manipulated image (such as standard font), or the original image (such as the handwriting) at the user's choice.

With the cholesteric liquid crystal device of the present invention, not only does the writing information appear on the writing panel directly, but also it can be simultaneously entered to a computer or other suitable electronic devices. In addition, it can be driven with a LCD driver to display information from a data source.

The following is an example of how to manufacture the cholesteric liquid crystal device described above. First, the substrates are cleaned, an ITO conductive layer is formed on the substrates, and a layer of photo-resist AZ1512 is coated on the ITO layer. The coated substrates are maintained at 90° C. for 30 minutes to pre-bake the photo-resist layer followed by exposing with UV light, developing, and baking at 110° C. for 30 minutes. Then, the ITO layer is etched using the patterned photo-resist layer as a mask to form ITO strips on both the top and the bottom substrates. After removing the remaining photo-resist layer, a layer of negative photo-resist OMR-83 is coated, by spin coating, on the bottom substrate covering the ITO strips followed by baking, exposing with UV light, spin developing, and rinsing by applying OMR-B, so that a predetermined portion of the negative photo-resist OMR-83 is removed and a cell structure with predetermined subcell size and shape is formed on the bottom substrate. In this step, the areas of subcells are aligned with the ITO strips and the subcell sidewalls are aligned with the line gaps between the ITO strips. Next, the transparent, flexible, top substrate is laminated with the bottom substrate with the ITO strips on the top substrate facing the cell structure on the bottom substrate. The ITO strips on the top substrate are aligned with the subcell areas while the line gaps between the ITO strips are aligned with the subcell sidewalls. The ITO strips on the top substrate are arranged perpendicular to the ITO strips on the bottom substrate so as to form an N×M electrodes matrix. Before laminating the two substrates together, but after aligning the two substrates or at the same time of the alignment, cholesteric liquid crystal is applied to the beginning joint edge of the two substrates. At the same time, spherical spacers are added too. Pressure is applied to the substrates by using a roller to mate the two substrates while, at the same time, continuously filling the cholesteric liquid crystal and the spacers. The laminated writing panel is then cured about 2 hours under a pressure of about 15 psi. A PCB board with a conductive layer (such as a copper layer) on both sides is provided, etching the PCB to form a comb-like electrode with x-direction strips (x-direction sensor) on one side and a comb-like electrode with y-direction strips (y-direction sensor) on the other side, so that an electromagnetic sensitive panel is formed. A signal IC amplifier is connected to the electromagnetic sensitive panel for detecting the movement of a pen tip. A driver(s) is electrically coupled to the writing panel. The electromagnetic sensitive panel is attached to the bottom substrate from behind by glue or by other mechanical mechanism such as screws.

The present invention has been described using exemplary embodiments. However, it is to be understood that the scope of the present invention is not limited to the disclosed embodiments. On the contrary, it is intended to cover various modifications and similar arrangement or equivalents. The scope of the claims, therefore, should be accorded the broadest interpretation so as to encompass all such modifications and similar arrangements and equivalents.

What is claimed is:

1. A cholesteric liquid crystal writing board comprising:
a transparent, flexible upper substrate comprising a first electrode, the upper substrate providing a writing surface for receiving a tip of a writing tool;
a lower substrate comprising a second electrode, the lower substrate being positioned facing the upper substrate;
a cell structure sandwiched between the upper substrate and the lower substrate, the cell structure having subcell sidewalls, wherein the subcell sidewalls, together with the upper substrate and the lower substrate, define a plurality of isolated subcells which are substantially not in fluid communication with one another; and
a cholesteric liquid crystal filled in the subcells, wherein the subcell sidewalls are substantially free of unpolymerized monomers and cholesteric liquid crystal molecules and are rigid enough so that, when the tip of the writing tool is forced against the writing surface and causes a flow of the cholesteric liquid crystal inside a subcell located directly under the tip, subcells neighboring said subcell will not be affected by the tip.

2. The cholesteric liquid crystal writing board of claim 1, wherein the subcells have a hexagonal shape when viewed from a direction perpendicular to the writing surface.

3. The cholesteric liquid crystal writing board of claim 1, wherein a size of the subcells is in the range from about 0.2 to about 0.5 mm.

4. The cholesteric liquid crystal writing board of claim 1, wherein a thickness of said subcell sidewalls is in the range from about 10 μm to 40 μm.

5. The cholesteric liquid crystal writing board of claim 1, wherein the subcell sidewalls is made of negative photo-resist OMR-83.

6. The cholesteric liquid crystal writing board of claim 1, wherein an aperture ratio of the cell structure is no less than about 70% and the subcell sidewalls are made of a transparent material or a material with black color.

7. The cholesteric liquid crystal writing board of claim 1, wherein the cell structure is formed by photoresistance or printing polymer.

8. A cholesteric liquid crystal writing/display device comprising:
a first transparent, flexible substrate having a first surface for writing information thereon by a writing tool and an opposite second surface;
a second substrate having a first surface facing the second surface of the first substrate;
a first electrode attached onto the second surface of the first substrate, wherein the first electrode comprises a predetermined number of conductive strips parallel to one another;
a second electrode attached onto the first surface of the second substrate, wherein the second electrode comprises a predetermined number of conductive strips parallel to one another, wherein the conductive strips of the first electrode are perpendicular to the conductive strips of the second electrode;
a cell structure sandwiched between the second surface of the first substrate and the first surface of the second substrate, the cell structure containing a plurality of isolated subcells defined by subcell sidewalls and the first and the second substrates, wherein the subcell sidewalls are substantially free of unpolymerized monomers and cholesteric liquid crystal molecules; and
a cholesteric liquid crystal filled in the subcells;
wherein the number and dimension of the conductive strips of the first and the second electrodes are so chosen that, when viewed from a direction perpendicular to the first surface of the first substrate, an area of each of the isolated subcells surrounded by the subcell sidewalls is fully covered by one of the conductive strips of the first electrode from a top side and by one of the conductive strips of the second electrode from a bottom side.

9. The cholesteric liquid crystal writing/display device of claim 8, wherein the subcells have an uniform square shape, the conductive strips of the first and the second electrodes have an uniform rectangular shape and an uniform line gap, wherein a width of the conductive strips substantially equals to a width of the subcells, the line gap substantially equals to a thickness of the subcell sidewalls, and the first and the second electrodes are so aligned relative to the cell structure that, when viewed from a direction perpendicular to the first surface of the first substrate, each overlapped area between the conductive strips of the first electrode and the conductive strips of the second electrode substantially equals to and fully covers the area of one individual subcell, while the line gap corresponds to area occupied by the subcell sidewalls.

10. The cholesteric liquid crystal writing/display device of claim 8, wherein the subcell sidewalls are made of a transparent material or a material with black color.

11. The cholesteric liquid crystal writing/display device of claim 8, wherein a thickness of the subcell sidewalls is about 10-40 μm and the line gap of the first and the second electrodes is equal to or smaller than the thickness of the subcell sidewalls.

12. The cholesteric liquid crystal writing/display device of claim 8, wherein a width of the subcells is about 0.2-0.5 mm and the width of the conductive strips of the first and the second electrodes is equal to or slightly larger than the width of the subcells.

13. The cholesteric liquid crystal writing/display device of claim 8, further comprising an LCD driver.

14. A cholesteric liquid crystal device for writing, inputting, and displaying information comprising:
a transparent, flexible, first substrate having an upper surface and an opposing lower surface, the upper surface serving as a writing surface for receiving a pressure from a tip of a writing tool, wherein the writing tool comprises means for generating a magnetic field;
a second substrate having a first surface and an opposing second surface, the second substrate being positioned below the first substrate with the first surface facing the lower surface of the first substrate;
a cell structure having subcell sidewalls sandwiched between the first substrate and the second substrate, wherein the subcell sidewalls define a plurality of isolated subcells;
a cholesteric liquid crystal contained in the subcells;
means for applying an electric field to drive states of the cholesteric liquid crystal in the subcells; and
an electromagnetic sensitive panel positioned proximately under the second surface of the second substrate for receiving the magnetic field generated by the writing tool;
wherein, when the tip of the writing tool is forced again and moved around the writing surface, a true track of the movement of the tip is directly shown on the writing surface, while information of the movement of the tip of the writing tool is sensed by the electromagnetic sensitive panel simultaneously.

15. The cholesteric liquid crystal device of claim 14, wherein the electromagnetic sensitive panel comprises:
a first sensor having a plurality of conductive leads parallel to one another, all of the conductive leads being electrically connected to one another at one end;
a second sensor having a plurality of conductive leads parallel to one another, all of the conductive leads being electrically connected to one another at one end, wherein the conductive leads of the first sensor are perpendicular to the conductive leads of the second sensor; and
an insulator layer between the first and the second sensors.

16. The cholesteric liquid crystal device of claim 15, wherein the first sensor is formed on the second surface of the second substrate.

17. The cholesteric liquid crystal device of claim 14, wherein the means for applying an electric field comprises:
a first electrode attached on the lower surface of the first substrate, wherein the first electrode has a plurality of conductive strips parallel to one another; and
a second electrode attached on the first surface of the second substrate, wherein the second electrode has a plurality of conductive strips parallel to one another, wherein the conductive strips of the first electrode are perpendicular to the conductive strips of the second electrode;
wherein the cell structure is sandwiched between the first and the second electrodes.

18. The cholesteric liquid crystal device of claim 14, further comprising an electronic device coupled to the eletro-magnetic sensitive panel for receiving signals from the eletro-magnetic sensitive panel and manipulating the signals.

19. The cholesteric liquid crystal device of claim 14, wherein the means for applying an electric field is coupled to an LCD driver.

20. The cholesteric liquid crystal device of claim 14, wherein the LCD driver is coupled to a data source so that information from the data source can be shown on the writing surface.

21. The cholesteric liquid crystal device of claim 14, wherein the subcell sidewalls are made of a transparent material or a material with black color.

22. A cholesteric liquid crystal device comprising:
a transparent, flexible first substrate having an upper surface and an opposing lower surface;
a second substrate having a first surface and an opposing second surface, the second substrate being positioned below the first substrate with the first surface facing the lower surface of the first substrate;
a writing tool having a tip for writing on the upper surface by generating a localized pressure thereon, and a device for generating a magnetic field while writing on the upper surface;
a cell structure having subcell sidewalls sandwiched between the first substrate and the second substrate, wherein the subcell sidewalls define a plurality of isolated subcells;
a cholesteric liquid crystal contained in the subcells;
a first electrode on the lower surface of the first substrate, wherein the first electrode comprises a plurality of conductive strips parallel to one another;
a second electrode on the first surface of the second substrate, wherein the second electrode comprises a plurality of conductive strips parallel to one another, the conductive strips of the first electrode are perpendicular to the conductive strips of the second electrode; wherein the first and the second electrodes can apply an electric field to drive states of the cholesteric liquid crystal in different subcells;
a first sensor attached to the second surface of the second substrate, the first sensor having a plurality of conductive leads parallel to one another, all of the conductive leads being electrically connected to one another at one end and to a first voltage detector at the other end;
a second sensor having a plurality of conductive leads parallel to one another, all of the conductive leads being electrically connected to one another at one end and to a second voltage detector at the other end, wherein the conductive leads of the first sensor are perpendicular to the conductive leads of the second sensor; and
an insulator layer between the first and the second sensors;
wherein, when the tip of the writing tool is forced again and moved around the writing surface, a true track of the movement of the tip is directly shown on the writing surface, while information of the movement of the tip of the writing tool is sensed by the first and the second sensors simultaneously.
